(19) United States
(12) Patent Application Publication
(10) Pub. No.: US 2017/0036275 A1
(43) Pub. Date: Feb. 9, 2017

(54) COLLET CHUCK FOR ROLLING ELEMENT SCREW DRIVE

(71) Applicant: Franz Haimer Maschinenbau KG, Hollenbach (DE)

(72) Inventor: Franz Haimer, Hollenbach (DE)

(21) Appl. No.: 15/230,714

(22) Filed: Aug. 8, 2016

(30) Foreign Application Priority Data
Aug. 7, 2015 (DE) 102015113099.8

(51) Int. Cl. B23B 31/20; F16H 25/22

(52) U.S. Cl. CPC B23B 31/20; F16H 25/2223; B23B 2260/116; B23B 2260/022; B23B 2231/2008

(57) ABSTRACT

A collet chuck with a chuck body, a collet, and a clamping nut in which the chuck body has a coupling section for coupling the collet chuck to the working spindle of a machine tool and has a collet holder embodied in the form of an inner cone and at least one thread groove for the screwing-on of the clamping nut; the collet has an outer cone, which is complementary to this inner cone, as well as a cylindrical tool holder; the collet chuck is embodied so that by tightening the clamping nut, the collet can be driven far enough into the collet holder that the tool shaft is held in a rotationally secured fashion; and the clamping nut has at least one thread groove; where rolling elements are inserted between the thread grooves of the chuck body and the clamping nut so that the clamping nut and the chuck body constitute a rolling element screw drive.

### FIELD OF THE INVENTION

The invention relates to a collet chuck.

### BACKGROUND OF THE INVENTION

Such collet chucks are known in a wide variety of embodiments. Typically, these collet chucks function in such a way that a collet that is flexible in the radial direction has an outer cone. The chuck body has a complementary inner cone. The collet is inserted into a clamping nut and then the clamping nut is loosely screwed onto the chuck body. The cylindrical tool shaft is inserted into the collet that is not yet deformed. Then with the aid of the clamping nut, the collet is driven into the conical seat of the chuck body until the tool shaft is clamped sufficiently for standard uses.

Considerable torques must be exerted on the clamping nut in order to overcome the friction forces on the conical seat and in the thread between the clamping nut and the chuck body and thus to drive the collet deep enough into the chuck body. Even with a firm tightening of the clamping nut, collet chucks have up to now in principle had a lower clamping force than for example the alternatively used shrink fit chucks, which is disadvantageous. Particularly with larger tool diameters and the accompanying high loads during machining, the conventional collet chucks quickly reach their limits.

In order to eliminate this problem, it has already been proposed in practice to drive the collet into the chuck body not with the aid of a clamping nut, but rather with the aid of a hydraulic press. In fact, this approach does make it possible to significantly increase the clamping force of a collet chuck. It is disadvantageous, however, that a press especially equipped for this purpose must always be kept on hand in order to drive the collet into the chuck body and in order to pull it out again to unclamp the tool from the chuck body. In addition, the operation is cumbersome because as a rule, a press is not available everywhere. Finally, there are also costs involved in the additional purchase of a press.

In light of this situation, the object of the invention is to produce a conventionally actuated collet chuck that overcomes the previous disadvantages of conventionally actuated collet chucks.

### SUMMARY OF THE INVENTION

The collet chuck according to the invention has a chuck body, a collet, and a clamping nut. In this case, the chuck body is equipped with a coupling section for coupling the collet chuck to the working spindle of a machine tool. The chuck body also has a collet holder embodied in the form of an inner cone and at least one thread groove to allow the clamping nut to be screwed on. With a multi-start embodiment, it is also possible for a plurality of thread grooves to be provided. The thread groove or grooves is/are provided to allow the clamping nut to be screwed on.

At the same time, the collet has an outer cone that is complementary to the above-mentioned inner cone as well as a generally cylindrical tool holder. The clamping nut in turn is equipped with at least one thread groove. In the case of a multi-start embodiment, it has a plurality of thread grooves. The thread groove or grooves of the clamping nut is/are embodied as complementary to the thread groove(s) of the chuck body.

The collet chuck according to the invention features the fact that rolling elements are inserted between the thread grooves of the chuck body and the clamping nut. The clamping nut and the chuck body thus constitute a rolling element screw drive.

This significantly reduces the thread friction between the chuck body and the clamping nut. This also makes it possible to produce a thread with a high load-bearing capacity since with a corresponding embodiment of the thread grooves, the rolling elements can rest with a larger area against the chuck body and the clamping nut as compared to the contact surfaces of conventional threads. Due to the reduced friction on the one hand and the higher load-bearing capacity of the thread on the other, the clamping nut is able to drive the collet with significantly greater force into the chuck body in the chucks according to the invention and thus produces a previously unknown amount of clamping forces.

It is particularly preferable for the rolling element screw drive to be embodied so that successive rolling elements touch one another inside the thread grooves. This achieves an increased load-bearing capacity of the thread since the highest possible number of rolling elements participates in the force transmission between the chuck body and the collet.

Ideally, the collet chuck according to the invention features the fact that at least one deflecting system for rolling elements is provided by means of which a rolling element that has reached the end of the thread grooves of the chuck body and clamping nut during the tightening of the clamping nut is transported back to the beginning of the thread grooves.

This makes it possible to significantly increase the number of rotations that the clamping nut travels on the chuck body between the “completely closed” position and the “completely open” position, even with a short design of the collet chuck. This makes it possible to use a smaller cone angle at the inner circumference of the collet holder and at the outer circumference of the collet. The cone angle (vertex angle of the cone, see FIG. 2, twice the value of the angle shown therein, labeled with the reference numeral 7) preferably lies between 0.5° and 6°, particularly preferably between 1° and 3°. It is thus possible for the collet to be driven in along a longer path and thus to produce correspondingly higher clamping forces with the same maximum torque on the clamping nut.

Ideally, the deflecting system is a tubular deflecting system. It is composed of a tubular conduit, which at the end of the thread grooves of the chuck body and clamping nut, discharges a rolling element from the thread grooves, transports it through a region outside the thread grooves to the beginning of the same thread grooves, and feeds it back in between the thread grooves. Ideally, this tubular deflecting system is embodied in the chuck body since the latter's wall thickness is great enough to accommodate such a tubular deflecting system without having to make the chuck as a whole significantly more massive, the latter being a particularly bad option since a larger chuck restricts the flexibility of the machine tool. This is because it is necessary to make sure that the chuck does not collide with the workpiece when moving along the working paths on the workpiece.

In a preferred embodiment, the tubular deflecting system is provided in a deflecting element that is embodied separately from the chuck body and clamping nut. This deflecting element is inserted into a first corresponding recess in the chuck body or clamping nut and is fixed in position therein.

Due to its tunnel-like embodiment, the tubular deflecting system is relatively difficult to produce. Because of this, it is advantageous if it is embodied in a part that can be manipulated separately from the collet chuck during production. In addition, this option offers the possibility of producing the tubular deflecting system out of a material that is easier to machine because it does not have to meet as high strength requirements as the material of the collet chuck itself.

It is particularly preferable if the deflecting element participates in the formation of the thread groove of the chuck body or the collet. The deflecting element thus intrinsically forms part or all of a tunnel for returning the rolling elements beneath the surface of the chuck body or collet. This tunnel passes through underneath the section with the thread grooves that the deflecting element supports on its side oriented toward the rolling element screw drive. This design makes it easier to not have to embody the deflecting element as an integral component of the collet chuck. Instead, it makes it possible to embody the deflecting element as a separate component, which is subsequently fixed in position in the collet chuck.

It has also turned out to be particularly advantageous to provide a second recess in the chuck body or clamping nut on the side of the chuck body or clamping nut diametrically opposite from the location in which the deflecting element is installed. A balancing element is inserted into this second recess and fastened therein. The balancing element compensates for the imbalance caused by the deflecting element. To this end, its mass and preferably also its mass distribution is selected so that it essentially or preferably completely compensates for the imbalance caused by the deflecting element and the rolling elements contained in it.

For this purpose, one option is to provide the balancing element with the same shape as the deflecting element and in particular to also provide it with a recess that corresponds to the tunnel of the deflecting element—with the sole difference being that on its side oriented toward the outer circumference of the collet chuck, the balancing element does not have an inlet or outlet for the tunnel so that the tunnel ends up being a cavity that is closed to the outside.

In this variant, the balancing element preferably also participates in the formation of the thread groove of the chuck body or the collet. It is thus possible to freely position the balancing element, particularly in the region of the thread groove of the chuck body or collet.

In the case of a multi-start thread, in particular a double-start one, the return of the rolling elements can be carried out separately for each thread, in particular by means of diametrically opposing deflecting elements—which can optionally also perform the necessary compensation if the deflecting elements have been positioned in a correspondingly precise way.

For many applications, it is preferable for the rolling elements to be embodied in the form of balls.

Ideally, the respective thread groove of the collet or preferably of the chuck body encloses the balls that it contains by more than 50% in at least one plane. If such an enclosure is embodied in the chuck body, then this prevents the balls from falling out of the chuck body even if the clamping nut is completely removed—for example in order to equip the chuck body with a different collet for a different tool shaft diameter.

Ideally, at least one thread groove has a flute, which preferably lies essentially or entirely outside the flow of force of the rolling elements. This flute admits foreign bodies such as abrasion debris, dirt that has worked its way in over time, and possible spalling from the rolling elements or the surface of the thread grooves. This prevents the rolling elements from repeatedly rolling over such foreign bodies and thus causing an excessive local pressure that damages the rolling surfaces of the rolling elements and/or the thread grooves after a relatively short time. Ideally, this flute is continuous, i.e. turns continuously with the thread groove in which it is provided. If the flute lies outside the flow of force that is transmitted from the sleeve part to the clamping nut via the rolling elements, then the rolling elements do not roll over the boundary edges of the flute under pressure. This ensures that no fatigue damage occurs at the flute edges of the kind that is to be feared when the rolling elements roll over the boundary edges of the flute under high pressure. The flute is preferably sunk into the thread groove at the deepest point thereof. It then nevertheless lies outside the flow of force since the flow of force to which the rolling elements are subjected during the tightening and/or loosening of the clamping nut travels diagonally through the rolling elements.

Preferably, the collet has a collar that protrudes from the collet holder. This collar is ideally embodied so that its outer circumference has a continuous, intrinsically closed rolling element-containing channel. In the place where the inner circumference of the clamping nut faces the outer circumference of the collar of the collet, the clamping nut likewise has a rolling element-containing channel. This makes it possible to connect the collet and clamping nut to each other through non-positive frictional engagement in the direction along the rotation axis of the chuck by means of rolling elements inserted into their rolling element-containing channels. The clamping nut and collet can nevertheless be rotated relative to each other without great friction losses, even when powerful forces are being exerted on them. This makes it possible to further reduce the torque necessary for clamping the tool or to increase the clamping action on the tool with the same amount of torque.

Here, too, the rolling elements are preferably embodied in the form of balls. The rolling element density is thus so high that the maximum possible number of rolling elements or balls is incorporated into these rolling element-containing channels so that in total, less than one rolling element- or ball diameter of air space remains between the successive rolling elements or balls. In this way, the collet and clamping nut are supported against each other over the greatest possible area. The rolling elements can therefore be installed without a rolling element cage. The distribution of rolling elements around the circumference of the rolling element-containing channels is nevertheless uniform enough that no appreciable imbalance can occur since the rolling elements are situated accordingly close to one another. Since there only minimal speeds occur when screwing on the clamping nut, it doesn't matter if balls that succeed one another in the circumference direction come into contact with one another with the actuation of the clamping nut.

It is particularly advantageous if the clamping nut is composed of two parts. It is then preferably composed of a first part, which supports the thread groove for receiving the rolling elements, and a second part, which has the rolling element-containing channel for connecting to the collet. It is particularly advantageous if the dividing line between the two parts is embodied so that after the connection between these two parts is detached, the second part together with the collet can be removed from the chuck body, while the first part remains on the chuck body. Ideally, this connection is embodied so that it can be released and reproduced without tools. To this end, it is optimal if a coupling in the form of a bayonet connector is provided between these two parts. It is likewise possible to provide alternative couplings such as a screw connection. In these cases, the above-mentioned first part of the clamping nut is sealed so that its seal relative to the chuck body is retained even when the second part of the clamping nut has been removed. The rolling element screw drive optimal thus remains optimally protected from environmental influences.

It is thus possible to reliably and quickly exchange the collet without having to disassemble the sealed rolling element screw drive and possibly expose it to contamination. The collet must be exchanged whenever the same chuck is used to clamp a tool shaft with a different diameter.

In another embodiment, a detachable connection can be integrated into the collar of the collet. The parting line preferably extending essentially parallel to the longitudinal axis can divide the outer annular section of the collar, which supports the rolling element-containing channel, from the inner sleeve-shaped part of the collet. As described above, the connection can be produced by means of a bayonet connector or a thread, particularly so that the inner sleeve-shaped part of the collet can be removed from the collet chuck, while the collar of the collet remains in place. When the collet is exchanged, it is only necessary to exchange the sleeve-shaped part of the collet. The remaining components remain on the clamping nut, which in this form, can once again be embodied as being composed of one piece. This embodiment is particularly inexpensive.

The clamping nut and chuck body are advantageously embodied so that when the maximum tightening of the clamping nut is reached, the clamping nut strikes against the chuck body, preferably with its end oriented away from the collet. This achieves definite conditions. This rules out a potential overtightening of the rolling element screw drive, which could occur due to the favorable friction conditions and would lead to a plastic deformation. Furthermore, in the clamped position, the collet always comes to rest in the same definite end position, which makes it easier to set the length of the tool.

Other advantages, embodiment options, and functions ensue from the following description of an exemplary embodiment based on the drawings.

Another advantage is achieved through the double contact of the clamping nut—at the end of the sleeve part and at a stop that is generally embodied as a shoulder on the sleeve part, against which the end of the clamping nut oriented away from the collar of the collet rests.

In this way, the clamping nut contributes to stabilizing the sleeve part and in many cases, also contributes to compensating for the weakening of the sleeve part by the deflecting system. This achieves an improved rigidity of the collet chuck.

It is also particularly advantageous to use a generative layer producing method such as the so-called laser sintering method to produce the collet chuck or at least to produce the chuck body. In this case, ceramic or metal powder is placed onto the entire area of a constructing platform in a thickness of 1 μm to 200 μm. The layers are sintered or melted into the powder bed in stages. The energy that is supplied by the laser is absorbed by the powder and results in a locally restricted sintering of particles, thus reducing the overall surface area. The constructing platform is then lowered slightly and a new layer is produced. The process is carried out layer by layer, preferably in the vertical direction. It is thus possible to produce even undercut contours, which particularly facilitates the precise production of the deflecting system according to the invention, which, despite its undercuts, can be embodied as an integral component of the wall of the sleeve part. It is thus possible to prevent the sleeve pan from being weakened by more than the inevitable amount.

### BRIEF DESCRIPTION OF THE DRAWINGS

FIG. 1 shows a general view of a collet chuck according to the invention, cut along the central longitudinal axis L.

FIG. 2 shows an enlarged detail from FIG. 1.

FIG. 3 shows the collet chuck according to FIG. 1 with the clamping nut removed, once again sectioned along the central longitudinal axis L.

FIG. 4 shows an enlarged detail from FIG. 3.

FIG. 5 shows a variant of the deflecting element 27 in a perspective view.

FIG. 6 shows the deflecting element according to FIG. 5 in a central longitudinal section.

FIG. 7 shows the deflecting element according to FIG. 5 in a side view.

FIG. 8 shows the deflecting element according to FIG. 5 viewed perpendicularly from above.

FIG. 9 shows how rolling elements in the form of ball bearings can be secured to prevent them from falling out.

FIG. 10 shows a rhomboid rolling element that can be alternatively used.

FIG. 11 shows a rolling element in the form of a cylindrical roller that can be alternatively used.

FIG. 12 is a sectional view of an alternative clamping nut with damping grooves of the kind that are preferably, but not exclusively, used for collet chucks according to FIGS. 1 through 11.

FIG. 13 shows a side view of the clamping nut according to FIG. 12.

FIG. 14 shows a sectional view of another alternative clamping nut with damping grooves of the kind that are preferably, but not exclusively, used for collet chucks according to FIGS. 1 through 11.

FIG. 15 shows a side view of the clamping nut according to FIG. 14.

FIG. 16 shows a detail of a collet with a removable collar.

FIG. 17, which largely corresponds to FIG. 2, shows a particular damping option at the location in which the end of the clamping nut oriented away from the collar of the collet comes into contact with the chuck body.

### DETAILED DESCRIPTION OF THE INVENTION

The Collet Chuck as a Whole

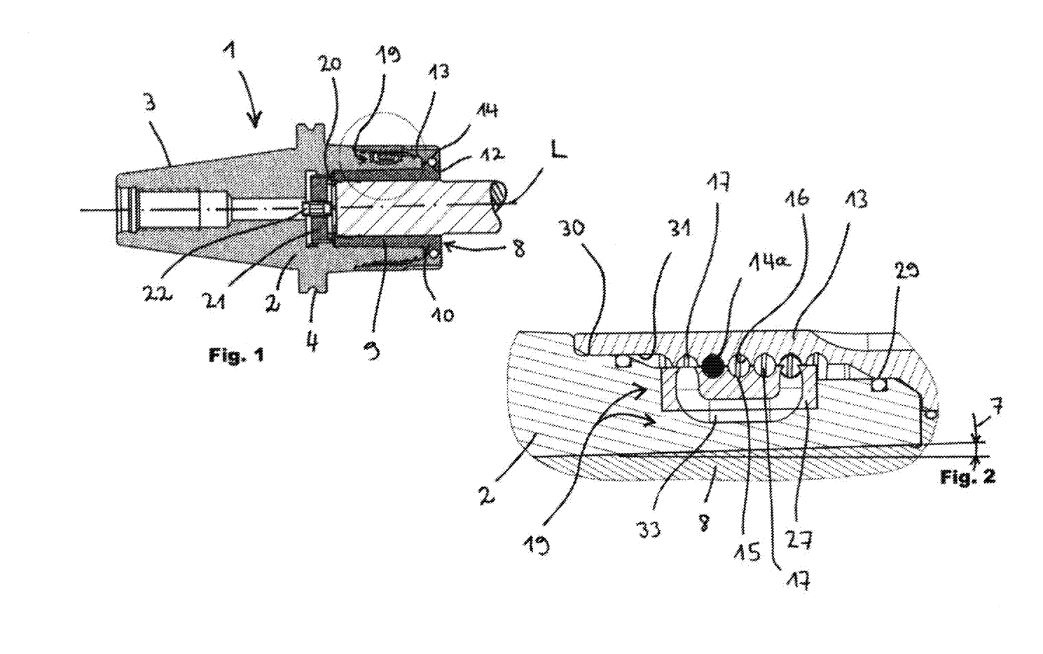

FIG. 1 gives a good overview of an exemplary embodiment of a collet chuck according to the invention.

As the drawing shows, the collet chuck 1 is composed of a chuck body 2. During proper operation, the chuck body rotates around the longitudinal axis L, which is then coaxial to the spindle rotation axis of the machine tool.

The chuck body has a coupling section 3, which in this case, is embodied in the form of a steep-angle taper. Other types of coupling sections, however, also lie within the scope of the invention, such as hollow shank taper couplings and the like. In addition, the chuck body 2 can have a manipulating section 4, which serves, for example, as a definite surface for the collet chuck 1 to be grasped by an automatic tool changer.

At its end oriented away from the coupling section 3, the collet chuck 1 has a sleeve part 5. This sleeve part 5 has a central bore or a central cavity. This cavity serves as a collet holder 6. The inner circumference surface of the collet holder is embodied in the form of an inner cone 7, see FIG. 2.

A collet 8 is inserted into the collet holder 6.

The Collet

The collet 8 is generally composed of a tubular section 9. Usually, it has a collar 10 formed onto the tubular section 9.

The collar 10 is generally used to actuate the collet, i.e. to drive the collet 8 into the collet holder 6. In many cases, the collar 10 is also used so as to be able to pull the collet 8 out from the collet holder 6 again after use, in opposition to the friction forces holding it therein, in order to be able to change the tool.

In a known way, the tubular section 9 of the collet has a number of slots generally extending parallel to the longitudinal axis L. These slots, however, do not extend all the way through the collet in the direction parallel to the longitudinal axis L. As a rule, some of the slots do not extend into the collar 10, while other, usually adjacent slots end shortly before the end of the tubular section 9 of the collet oriented away from the collar 10. It is thus possible to compress the collet.

On its outer circumference surface, the collet is conical. It generally has the same cone angle as the inner cone of the collet holder 6, once again see FIG. 2. In special cases, the two angles can also differ slightly from each other in order to achieve special clamping effects. For example, it can be desirable to slightly increase the clamping force in the rear region of the collet remote from the collar 10 relative to the clamping force in the front region. In this case, the cone angle of the collet can be selected to be somewhat smaller than the cone angle of the collet holder. But the reverse case can also be advantageous.

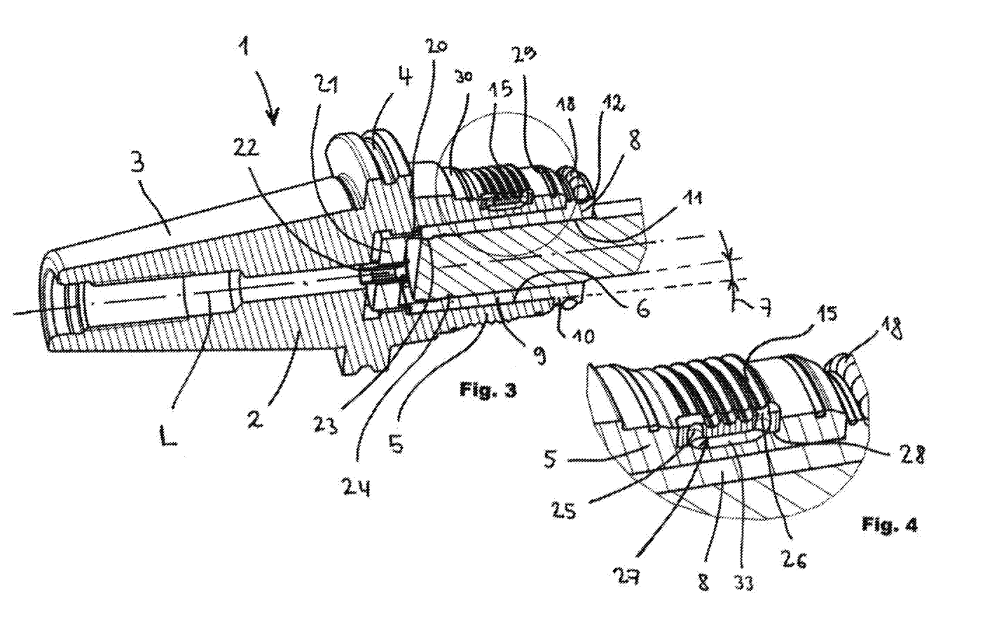

Preferably, the collet is embodied so that at its end oriented away from the collar 10, it transitions via a connecting strut 20 into a collet bottom 21, see FIG. 3. The connecting strut 20 is embodied as thin-walled so that it does not impair the ability of the collet to be compressed in the radial direction. The collet bottom 21 is preferably provided with an internal thread into which a length-adjusting screw 22 can be screwed. This makes it possible to adjust how deep the tool shaft can be slid into the collet. This is important in order to be able to carry out a precise machining on numerically controlled machines. This is because numerically controlled machines are informed that the tool tip is located at a precisely determined position so the tool shaft can only be inserted to a certain depth in the collet 8 depending on the specific machining case.

As is clearly evident, the outer circumference of the collar 10 of the collet 8 is provided with a rolling element-containing channel 12, once again see FIG. 3.

As stated above, one option is for the collet 8 to be composed of two parts in such a way that the collar of the collet, which usually constitutes a rolling element-containing channel, always remains connected to the clamping nut in a form-locked fashion.

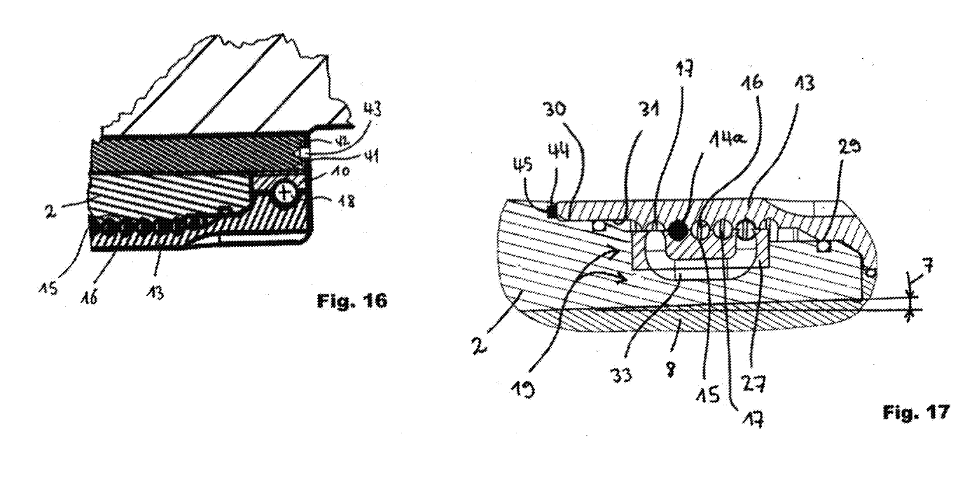

The sleeve-shaped part 42 of the collet, which predetermines the diameter of tool shafts that it is able to clamp, can be detached from the collar 10 and then pulled out from the collet chuck 1 in order to perform the exchange, ideally without separating the clamping nut from the rolling element screw drive and thus having to open it. Such an embodiment is illustrated in FIG. 16.

In this case, the collar 10 of the collet is connected to the sleeve-shaped part of the collet by means of a thread 41. The thread is preferably embodied so that the friction in the thread under load is greater than the torque that is transmitted to the collar 10 of the collet via the rolling elements 18 when releasing the collet, i.e. when loosening the clamping nut from the latter. This ensures that the collet really is driven out of its seat in the chuck body by the loosening of the clamping nut instead of merely rotating along with the collar. For the same purpose, the threads can be embodied so that the thread of the clamping nut and the thread 41 can have different pitches.

In this case, the mouth of the sleeve-shaped part 42 of the collet can have a hex socket attachment by means of which the sleeve-shaped part 42 can be unscrewed after the collet has been driven out from the collar 10 again. Alternatively, the free end of the sleeve-shaped part 42 of the collet can have engaging openings 43 for a pin wrench, similar to those used for fastening and detaching the cutting wheels of an angle grinder. In order to prevent the collar 10 from rotating at the same time, it can be equipped with similar engaging openings, not shown in the drawing here.

As another alternative, a bayonet connector can be provided between the collar 10 and the sleeve-shaped part 42, which is likewise not shown in the drawing here.

From an entirely general standpoint, the connection between the sleeve-shaped part 42 of the collet 8 and its collar 10 can preferably be detached without tools.

The Clamping Nut

All of the details of the clamping nut are described in the following chapter “The Interaction between the Collet and the Clamping Nut.”

It should therefore be initially stated at this point only quite generally and without being shown in the drawings, that it is particularly advantageous to embody the clamping nut as being composed of two parts.

In this case, the clamping nut is composed of a first part and a second part. The first part, together with the rolling elements and the chuck body, constitutes the rolling element screw drive and always remains on the chuck body, i.e. is only removed from it for repair purposes, using the tool that is required for this. The connection between this first part of the clamping nut and the chuck body is embodied so that it cannot be detached during regular operation, i.e. as part of a tool change. At the same time, a seal is provided, which is positioned and embodied so that the rolling element screw drive always lies in a sealed fashion between the first part of the clamping nut and the chuck body, even when the second part of the clamping nut has been detached from the first part of the clamping nut and removed in order to exchange it together with the collet that is fastened to it for another unit composed of a collet and the corresponding part of the clamping nut.

The clamping nut is preferably embodied so that its second part can be removed from its first part without requiring a tool. Preferably, a kind of bayonet connection is used for this purpose.

The Interaction Between the Collet and the Clamping Nut

The collet chuck 1 also includes a clamping nut 13. This clamping nut preferably has its thickest region at the place where it encompasses the outer circumference of the collar 10 of the collet 8 when properly assembled. On the inner circumference located there, the clamping nut 13 is in turn provided with a rolling element-containing channel 14. The rolling element-containing channels are preferably filled with balls or rolling elements via a bore that is not shown in the drawing so that the collet 8 and clamping nut 13 are connected to each other. With the aid of the rolling elements 18 accommodated between their rolling element-containing channels 12 and 14, the clamping nut 13 can exert forces on the collet 8 that are oriented parallel to the longitudinal axis L. As a rule, the clamping nut 13 is thus able to both drive the collet 8 into the collet holder 6 and pull it back out again. In this case, only a minimum of friction is generated between the clamping nut 13 and the collet 8 since the rolling elements 18 roll between these two components. In most cases, the rolling elements rest without a cage between the rolling element-containing channels 12 and 14. Generally, though, they are packed so densely that there is no distance or essentially no distance between them or only a distance that is less than ⅙ the diameter of a rolling element. It is thus possible to transmit forces between the collet 8 and the clamping nut 13 with little friction loss.

The Rolling Element Screw Drive

As is clear from FIG. 2, the chuck body 2 is provided with a thread groove 15. The thread groove 15 is situated in the region in which forces, which are oriented essentially parallel to the longitudinal axis, can be transmitted between the chuck body 2 and the clamping nut 13. This thread groove extends in helical fashion like a screw thread, turning preferably more than four times or better still, more than five times around the chuck body 2. Preferably, balls are used for the rolling elements. The thread groove then has a semicircular cross-section; otherwise, it has some other cross-section that is adapted to the relevant rolling elements.

Preferably, a flute 17 is provided in the region of the deepest point of the thread groove 15. This flute 17 forms a recess into which the rolling element does not reach, even when a rolling element is rolling over it. Because of this, dirt, abrasion debris, or spalling caused by fatigue, which may in time have gotten into the region of the thread grooves and rolling elements and which originates from these components, collects in the flute 17. These foreign bodies then quickly travel out of the impact region of the rolling elements, in fact before they are rolled over with a powerful force by rolling elements, thus causing damage to the rolling elements or the thread grooves. The flute 17 is positioned so that it lies outside the force lines that lead from the nut through the rolling elements to the chuck body during the tightening or loosening. In this way, the flute 17 is at least not rolled over by the rolling elements when they are being acted on with force.

As is also clearly evident from FIG. 2, the inner circumference of the clamping nut 13 is provided with a corresponding thread groove 16. The thread groove 16 generally has the same cross-sectional type as the thread groove 15. The thread groove 16 is therefore likewise embodied as semicircular in this case. A flute 17 of the above-described type can be provided in the thread groove 16 and/or 15. Between the two thread grooves, a number of rolling elements 14a are inserted, which in this specific embodiment, are embodied in the shape of balls. Usually, the material used for the balls is a steel that has been hardened or quenched and tempered and then ground, as is known from the balls used in other ball bearings. Alternatively, however, it is also possible to use balls made of ceramic or other sufficiently resistant materials.

The thread groove 16 of the clamping nut 13 also extends in helical fashion like a screw thread along the inner circumference of the clamping nut 13. If the rolling element screw drive does not have a return, then the thread grooves 15 and 16 preferably have an approximately identical number of turns. In this case, only some of the turns are filled with rolling elements, which are then preferably held equidistant from one another with a kind of cage. But if a return is provided, then the thread grooves 15 or 16 that contain the return are preferably completely filled with balls. The one thread groove 15 or 16 in this case has more turns than the other, in fact at least one or better still, two turns more than it.

A variant that has turned out to be particularly advantageous is shown in FIG. 9. To be specific, the thread groove 15 of the chuck body preferably 2 encloses the rolling elements 14a or balls allocated to it by more than 50%, preferably by at most 55%, see FIG. 9. This holds the rolling elements in the thread groove 15 of the chuck body 2 even when the clamping nut 13 is completely unscrewed from the chuck body 2 and removed from it. Naturally, a kinematic reverse can also be provided. The expression “kinematic reverse” here means that the thread groove 16 of the clamping nut 13 encloses the rolling elements 14a or balls allocated to it by more than 50% in one plane. This embodiment, however, is not preferable since the clamping nut 13 would then have to be embodied with unnecessarily thick walls.

In order to be able to embody the rolling element screw drive to be as short as possible in the direction parallel to the longitudinal axis L, at least one deflecting system 19 is provided. The function of the deflecting system 19 is for a rolling element, which, with the rotation of the clamping nut 13, has reached the end of the thread grooves 15 or 16 in which the deflecting system 19 is accommodated, to be transported back to the beginning of the thread grooves—where the terms “beginning” and “end” are preferably, but not necessarily, to be understood as absolute. Rolling elements can also be captured and returned even before the absolute end of a thread groove.

In the following, the function of the deflecting system 19 will be described in detail for the case in which it is attached to the thread grooves 15 of the chuck body 2. For purposes of an optimal return, the deflecting system 19 is preferably embodied as a so-called tubular deflecting system. At the end of the thread, such a deflecting system constitutes a tunnel tube, which, after the tunnel portal, initially extends in the radial direction (preferably at least in a diagonally inward direction), then transitions into the main part of the tunnel that passes through under the thread grooves 15, and then comes up again in corresponding fashion at their beginning. This structure composed of the above-mentioned sections is referred to as a whole as the “tunnel 33.” The inlet 25 of the deflecting system 19 is embodied so that a rolling element 14a found there is forced by the following rolling element 14a to travel into the inlet 25 of the deflecting system 19 and then to travel down into it. The outlet 26 of the deflecting system 19 is embodied so that a rolling element 14a that is coming up again there travels back into the space between the thread grooves 15 and 16, is then captured there by frictional, nonpositive engagement, and then rolls between the thread grooves 15 and 16.

Naturally, the positions of the “inlet” and “outlet” of the deflecting system depend on the rotation direction of the nut. The inlet 25 and outlet 26 in FIG. 4 are shown by way of example for the loosening procedure.

The deflecting system 19 can be an integral component of the chuck body 2. The latter is the case, for example, when the chuck body 2 is produced by means of powder metallurgy or sintering. Preferably, however, the deflecting system 19 is composed of a special deflecting element 27, which is produced as a separate part. This deflecting element 27 is then inserted into a corresponding recess 28 on the circumference of the sleeve part 5 of the chuck body 2 and fastened there, possibly by means of welding or gluing.

The special feature of the deflecting element 27 in this case lies in the fact that the deflecting element constitutes not only a tunnel 33 for returning the rolling elements 14a, but also a section of the thread groove 15 on the side oriented toward the chuck body 2. This is depicted very clearly in the drawings. The deflecting element thus closes the gap in the thread grooves 15 that comes into being with the production of the recess 28 accommodating it on the circumference of the chuck body.

Usually, the deflecting element has only a relatively short span in the circumference direction, for example at most 1/10 the circumference length of the region in which the recess 28 accommodating it is located on the chuck body. Because of this, it is particularly preferable to embody the deflecting element 27 as a plastic block, which simplifies production considerably. Because of this property, the deflecting element 27 itself naturally cannot transmit forces of any consequence between the thread groove 15 of the collet chuck 1 and the thread groove 16 of the clamping nut 13. But this does not matter since this loss of load-bearing capacity is negligible due to the small span of the deflecting element 27 in the circumference direction.

As is clear from the drawings, see FIG. 2, it can be advantageous to embody the deflecting element so that the tunnel 33 for returning the rolling elements 14a does not lie entirely inside the deflecting element 27, but rather is partially also comprised in the chuck body 2 itself. As a result, the tunnel 33 in the deflecting element 27 can be more easily produced since it is open on the back side of the deflecting element and only becomes the intrinsically completely closed tunnel 33 (apart from the two tunnel portals at the beginning and end) when the deflecting element 27 is brought into alignment with the complementary section of the tunnel partially embodied in the chuck body 2 and thus the open back side of the deflecting element 27 that forms one part of the tunnel is brought into alignment with the other part of the tunnel 33 that is formed in the chuck body 2. Such an embodiment has the advantage that the tunnel 33 can be incorporated into the deflecting element 27 with relative ease because it is accessible from the back side of the deflecting element 27. At this point, it should be noted that the tunnel 33, at least in its middle region, does not have to be produced with special precision. It can easily be significantly larger here than the individual rolling elements 14a. The tunnel only has to be embodied so that the rolling elements 14a do not stick in place, but instead can be easily pushed through the tunnel 33. It is important that the inlet 25 of the deflecting element 27 and the outlet 26 of the deflecting element 27 be precisely embodied so that the rolling elements 14a can pass through them smoothly as they are being introduced and discharged again.

In a preferred embodiment, in the vicinity of the inlet 25 and outlet 26 of the deflecting element (the inlet and outlet are also referred to as “tunnel portals”), the thread grooves 15 has a slight, for example funnel-shaped, widening so that the powerful exertion of pressure to which the rolling elements 14a are subjected gradually decreases in the vicinity of the inlet 25 and gradually increases again in the vicinity of the outlet 26. In this way, the rolling elements 14a roll over the edges at the ends of the thread grooves 15 almost without any load, without damaging them. In particular, the reintroduction of the rolling elements 14a into the thread groove 15 is significantly facilitated since the rolling elements can initially be slid without force into the vicinity of the thread groove 15 and then in the vicinity of the narrowing, the exertion of pressure and thus also the friction between the thread grooves and the rolling elements gradually increases and the rolling elements roll all by themselves, so to speak, into the region where the full load is exerted.

In conclusion, it should additionally be noted that the rolling element screw drive can also include a plurality of thread grooves in the chuck body and collet. These then each constitute a kind of multi-start thread. For example, if a two-start thread is formed, then there are two sets of rolling elements, which travel in threads that are separate from one another.

Consequently, two deflecting elements that function independently of each other are then mounted on the chuck body or alternatively on the clamping nut.

Furthermore, in an embodiment that is particularly favorable, but not shown in the drawing, the pitch of the thread grooves 15, 16 is modified. Preferably, the pitch of the thread grooves 15, 16 in the region that is passed through last when the clamping nut 13 is being tightened, is less than in the region before it. In this way, it successfully exerts a particularly high pressure on the collar 10 of the collet 8 at the end of the tightening movement. As a result, the collet can be driven in with the greatest possible force with the same tightening torque and can thus be closed very tightly.

Such an embodiment of the thread grooves 15, 16 requires a careful selection of the play of the thread grooves 15, 16 relative to the rolling elements 14a. This is because an appropriate amount of play must be provided in order to ensure that the preceding sections of the respective thread groove 15 or 16, which are still engaging and have the slightly higher pitch, prevent the exertion of force that is produced in the section of the thread groove 15 or 16 with the lower pitch—so that the clamping nut is essentially distorted on the chuck body.

The Sealing of the Rolling Element Screw Drive

The chuck body 2 has a respective sealing section 29 and 30 before and after the deflecting system 19 in the direction of the longitudinal axis L. In this case, both sealing sections are provided with a groove into which an O-ring is inserted. It is also possible to use other seals. It is important that the clamping nut 13, at its end oriented away from the collet, has an inner circumference surface 31 that is suitable for supporting a seal. The inner diameter of this inner circumference surface 31 must be large enough that it can be slid unhindered over the thread groove 15 of the chuck body that is already equipped with the rolling elements 14a.

The Pullout Protection

Another option that has turned out to be extremely useful specifically also in the chucks according to the invention, is so-called pullout protection.

Even when tool shafts are frictionally clamped with a powerful force, there is the danger that the influence of the vibrations that inevitably occur in the tool during machining will cause the tool shaft to migrate in the axial direction. Even slight movements of the tool shaft relative to the collet 8 are critical for the machining, though, since the necessary high machining precision can no longer be assured.

Such a pullout protection prevents the tool shaft socket from migrating in the axial direction. In order to provide such a pullout protection, a so-called locking element is provided on the inner circumference of the tool shaft socket embodied by the collet 8, see FIG. 3. Such a locking element 23 is generally embodied in the form of a projection that protrudes inward in the radial direction beyond the adjacent inner circumference surface of the collet 8. This can be embodied in the form of a thread that extends in the circumference direction or can be embodied in the form of a local projection. The latter can optionally also have a thread section that extends only a short distance in the circumference direction.

Often, a plurality of such projections is provided. Preferably, these are distributed over the circumference at equal angles from one another when viewed in the circumference direction. In other words, they all enclose the same angles between themselves—at least when they are projected onto a plane perpendicular to the longitudinal axis L. Ideally, this projection is integrally connected to the collet 8, i.e. it is composed of the same material and of one piece with the collet 8.

Then a corresponding, usually thread-like, helically extending, or bayonet connector-like locking groove 24 is provided in the tool shaft. The locking groove 24 can be brought into engagement with the locking element 23 or the plurality of locking elements 23, thus achieving an axial pullout protection.

Naturally, a kinematic reverse can also be provided. In the latter case, at least one locking element 23 protrudes in the radial direction (usually locally) beyond the outer circumference surface of the tool shaft socket and can be screwed into a corresponding locking groove 24, which is then embodied on the inner circumference of the tool shaft socket 11 d. That which has been stated above applies analogously.

It is thus likewise possible within the scope of the invention to embody a locking element 23 on a Weldon shaft of a tool in such a way that an insert is inserted into the Weldon recess beyond which the locking element protrudes outward in the radial direction. The tool shaft, together with the insert, is then screwed into a corresponding locking groove 24 in the collet 8. In this example, it is clear that from an entirely general standpoint, even locking elements that are not of one piece with the tool shaft or collet 8, but are instead provided as separate individual parts are in accordance with the invention.

It should also be noted that in a particularly preferred embodiment, the collet is in turn secured to the chuck body in a form-locked way that prevents rotation relative to the chuck body.

Ideally, such a rotation prevention is achieved by the collet bottom 21 not being provided with a circular cross-section perpendicular to the longitudinal axis L. It is particularly advantageous to provide the collet bottom with a polygonal cross-section, in the best case with a quadrilateral polygon.

The chuck body then has a corresponding recess in a corresponding location.

The polygonal shape has the advantage that it only causes slight stress concentrations due to the flat design. In addition, the inner polygon in the receiving body can be easily produced by milling due to the rounded corners.

Variation of the Deflecting System

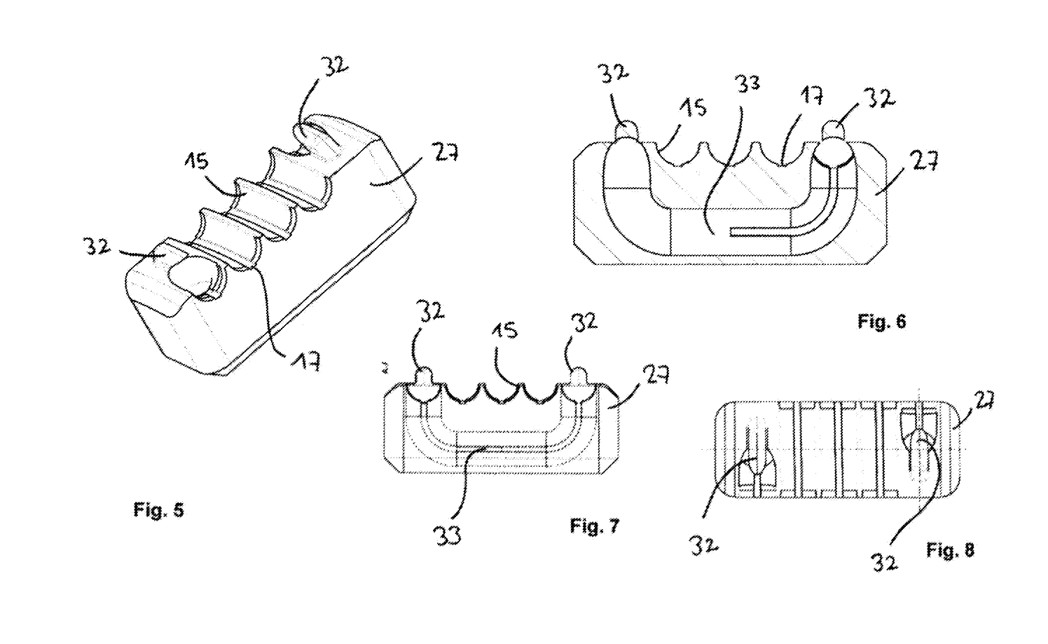

FIGS. 5 through 8 show an especially embodied deflecting system for use in a chuck (at least comprised of a chuck body, collet, and clamping nut) shown in FIGS. 1 through 4.

In this deflecting system, the deflecting element 27 is provided with a rolling element catching device 32 that is preferably embodied as an integral component thereof. This is preferably embodied in the form of a hood that protrudes into the thread groove 15, 16 of the respective matching piece. If the deflecting element 27 is a component of the chuck body 2, then the hood protrudes into the thread groove 16 of the clamping nut 13; otherwise, the reverse is true. The cross-section of the hood here is preferably at least 30% narrower than the cross-section of the thread groove 15, 16 into which it protrudes. At the same time, the hood protrudes like a roof over the mouth- or portal cross-section of the tunnel 33.

The rolling element catching device 32 always catches the rolling element that has just reached the end of its usable thread groove 15, 16 and forces the rolling element 14a to travel down into the tunnel 33 of the deflecting element 27. A rolling element catching device 32 embodied in this way is thus is not dependent on the force of gravity to compel the respective rolling element 14a to travel down into the tunnel 33 of the deflecting element 27. This results in a higher operational reliability, particularly over the long term, if some penetration of dirt has occurred.

FIGS. 5 through 8 also clearly show that the above-described flute 17 for receiving dirt and abrasion debris in a way that renders them harmless is preferably also embodied along the tunnel 33 of the deflecting element 27.

Variation of the Rolling Elements

Instead of using balls, another variant of the chuck according to the invention uses rolling elements in the form of rhomboid rollers 35, as cross-sectionally depicted in FIG. 10—otherwise, this variant corresponds to the embodiment described above so that everything that has been stated above, provided that it does not pertain exclusively to the rolling elements embodied in the form of balls, also applies to this exemplary embodiment.

These rolling elements have the shape of two straight truncated circular cones that are joined together at their bases and preferably have a cone angle ALPHA, see FIG. 10. In cross-section, this produces a rhomboid area with the tips cut off. These rolling elements rotate about an axis 34, which essentially or preferably extends completely parallel to the longitudinal axis L of the collet chuck 1. Rolling elements of this kind—in comparison to ball bearings—can be supported against the chuck body 2 and clamping nut 13 over a larger area and are thus able to transmit significantly higher forces with minimal friction losses. This makes it possible to produce collet chucks that have a high clamping- and holding force, which has not been known up to this point in nut-actuated collet chucks.

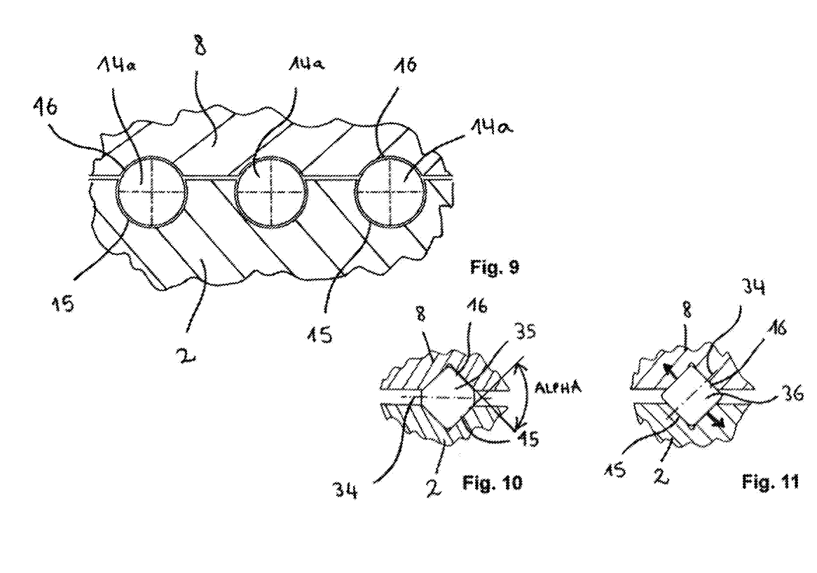

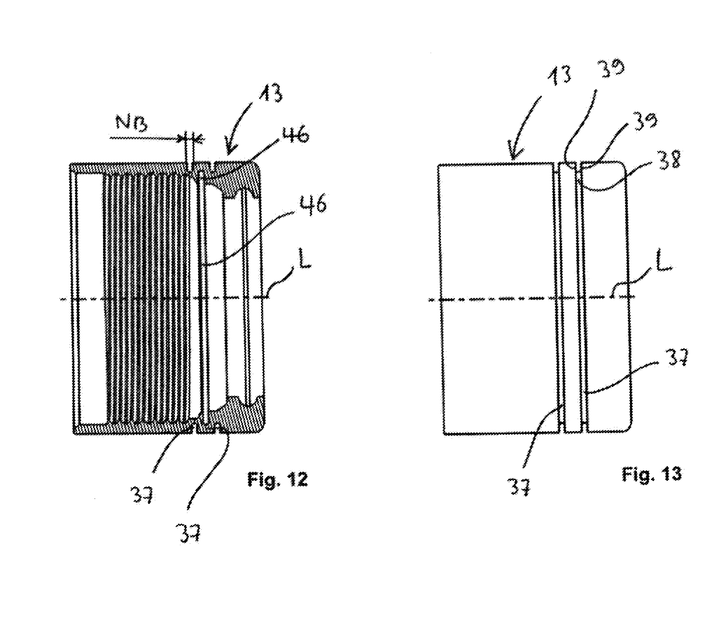

An efficient variant of the collet chuck according to the invention that is similar from a force transmission standpoint is shown in FIG. 11. In this case, instead of the rhomboid rolling elements 35, cylindrical rollers 36 or (more rarely) barrel-shaped or conical rolling elements are used. Their rotation axis 34 extends diagonally relative to the longitudinal axis L of the collet chuck.

All of the statements made above in relation to the embodiment that uses balls as the rolling elements apply correspondingly to these two latter variants of the collet chuck according to the invention.

Is should also be noted that within the scope of the invention, other suitable forms of rolling elements can be used in analogous fashion.

Special Damping of the Clamping Nut

Last but not least, it should be noted that independent of the other features described in this application for a collet chuck, protection is also claimed for a collet chuck with the features described below—even though this type of damping is particularly useful in the above-described collet chucks.

FIGS. 12 and 13 show a clamping nut 13 that is preferably used for collet chucks 1 according to FIGS. 1 through 11.

This clamping nut 13 features two flutes 37 that are embodied in the form of annular grooves.

The flutes 37 increase the elasticity of the clamping nut 13 and provide it with a vibration-damping influence—quite particularly, but not exclusively, in collet chucks 1 whose clamping nut 13 is secured to the chuck body 2 in rotating fashion with the aid of a rolling element screw drive of the above-described type.

It is preferable to provide two flutes 37 extending parallel to each other, but in some cases, the desired effect can also be achieved with a single flute so that in the following, the representative expression “the at least one flute 37” is used.

As shown in FIGS. 12 and 13, the at least one flute 37 is preferably embodied in the form of a flute that is endless in the circumference direction, i.e. is intrinsically closed, since in many cases, flutes that are embodied as only local and not endless in the circumference direction do not provide sufficient weakening.

Preferably, the at least one flute 37 is open toward the circumferential surface of the clamping nut 13, as shown in FIG. 13.

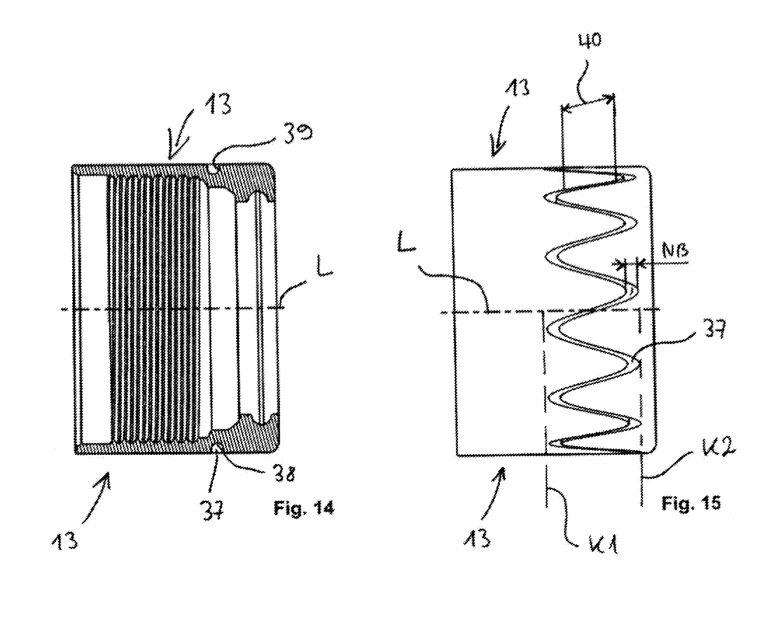

The flute bottom 38 can be embodied as predominantly flat, as shown in FIG. 12. Preferably, the flute bottom 38 is rounded and ideally—at least essentially—has a profile in the shape of a segment of a circle, also see FIG. 14.

Ideally, the at least one flute 37 is an annular groove. Its lateral flute side walls 39, which transition into the (possibly rounded) flute bottom 38, can then each lie in a plane that lies (entirely or essentially) perpendicular to the longitudinal axis L of the collet chuck, see FIG. 13. The expression “essentially” here means that a V-shaped diagonal position of the flute side walls 39 is harmless, particularly if the flute bottom 38 is not also embodied as V-shaped and therefore an excessive notch effect does not occur.

It has turned out to be particularly advantageous to provide the at least one annular flute 37, which is designed to be a weakening groove, in the section of the clamping nut 13 that lies between the section with which the clamping nut 13 rests against the collet 8 directly or with the interposition of rolling elements and the section of the clamping nut 13 in which the thread groove(s) 16 is/are provided over its entire inner circumference surface, see FIG. 12. In this regard, it should be noted that even the flute 37 shown on the left in FIG. 12 does not lie in a section of the clamping nut in which the latter is provided with thread grooves 16 over its entire inner circumference surface.

In other words, one could say that the at least one flute 37, if it is an annular groove, should lie entirely in the region of the clamping nut 13 in which it transmits the most powerful forces in the direction parallel to the longitudinal axis L of the collet chuck 1.

The damping effect can be significantly amplified through a combination of external flutes 37 with at least one internal groove 46, which is provided on the inner circumference of the clamping nut 13, preferably between the flutes 37, viewed in the direction along the longitudinal axis L. That which has been said above with regard to the flute 37 preferably also applies to the embodiment of the internal groove 46 as such.

It is even better if a flute 37 is embodied as a flute 37 that meanders like a wave, as shown in FIG. 15.

As indicated in FIG. 15, the meandering flute—viewed in the circumference direction—is preferably likewise embodied as intrinsically completely closed, i.e. is “endless.”

It has surprisingly turned out that a meandering flute 37 that is predominantly composed of flute sections 40 that do not extend exclusively in the circumference direction, but preferably predominantly in a direction oblique thereto, produces a particularly pronounced damping action, particularly with a superposition of bending- and rotating oscillations. As a rule of thumb for establishing a meandering flute 37 that produces a perceptible damping action without being excessively weakened, it can be said that the maximum extension of the flute 37, measured in the direction parallel to the longitudinal axis L of the collet chuck, should be at least four times and preferably at most ten times the maximum flute width NB, measured perpendicular to the local longitudinal axis of the flute.

Ideally, the meandering flute 37 exhibits a regular wave pattern, preferably with a constant frequency—at any rate in the sense that there are only two imaginary circles K1 and K2 that are both oriented perpendicular to the longitudinal axis L of the collet chuck, one of these circles (K1 here) being tangential to all of the reversal points of the flute and the other of these circles (K2 here) being tangential to all of the reversal points of the flute 37 on the opposite side so that the flute 37 in its entirety is situated between the two circles.

It has turned out to be particularly advantageous here if the meandering flute 37, which is embodied as a weakening groove, is provided predominantly or even over at least 70% of its length in the section of the clamping nut 13 that lies between the section with which the clamping nut 13 rests against the collet 8 directly or with the interposition of rolling elements and the section of the clamping nut 13 in which the inner circumference surface of the nut is provided with thread grooves 16 over its entire surface, see the overview in FIGS. 14 and 15.

In order to further increase the damping action, the at least one flute 37 embodied as a weakening groove can be filled with an elastomer.

To conclude this “Special Damping” section, it must therefore be stated that independent protection is also claimed for a collet chuck with a clamping nut of the type described above in conjunction with FIGS. 12 through 15, which does not absolutely depend on the features of the initially described collet chucks with the rolling element screw drive. Basically, the same thing applies to the clamping nut described in conjunction with FIGS. 12 through 15 as such, on its own.

Consequently, independent protection is also claimed for a collet chuck 1 with a chuck body 2, a collet 8, and a clamping nut 13 in which the chuck body 2 has a coupling section 3 for coupling the collet chuck to the working spindle of a machine tool and a collet holder 6 preferably embodied in the form of an inner cone and is provided with at least one thread groove (single-start/multi-start) for the screwing-on of the clamping nut and in which the collet 8 preferably has an outer cone that is complementary to this inner cone, as well as a cylindrical tool holder 11, and the clamping nut, preferably on its outer circumference—and ideally on its outer circumference and its inner circumference, respectively—has at least one, preferably several, flutes that weaken(s) it.

In this connection, a thread groove is not such a “damping groove” as defined by the invention since a thread groove, because of its different position and embodiment, does not have the desired damping action.

In this context, a “thread groove” is understood to be either a thread component, regardless of whether it is a thread whose thread grooves slide directly against each other or it is preferably a thread with an interposed rolling element screw drive, as described in the beginning.

The above-described collet chuck or its clamping nut can optionally have additional features of the kind that have been explained above in conjunction with FIGS. 12 through 15 and/or additional features to which the disclosure content above in connection with FIGS. 1 through 11 and/or in the introduction to the description and/or in the claims hereinafter also applies.

Independent of what has been stated above, it should be noted that according to the invention, a different damping measure has been proposed for the clamping nut, as illustrated in FIG. 17.

As is clear from the drawing, the clamping nut 13 and the chuck body 2 here are embodied so that the end of the clamping nut 13 oriented away from the collar 10 of the collet 8 strikes against the chuck body 2 when the maximum tightening of the clamping nut 13 has been reached. In this case, the end of the clamping nut 13 oriented away from the collar 10 of the collet 8 preferably does not strike directly against the chuck body over its entire area, but rather with the interposition of an elastically flexible element, preferably in the form of a plastic- or elastomer ring 45. This simple measure also makes it possible to make a surprisingly effective contribution to avoiding vibrations.

In this context, it can be particularly advantageous if the above-mentioned plastic- or elastomer ring 45 is installed, e.g. in a correspondingly dimensioned flute 44, so that the clamping nut 13 initially compresses and thus clamps the plastic- or elastomer ring 45 in such a way that at the very end of its tightening movement, it does in fact finally come into direct contact with the chuck body 2.

On the one hand, this produces a vibration-damping prestressing of the plastic- or elastomer ring 45, but on the other hand, it ensures that the fully tightened clamping nut 13 and together with it, the collet 8, viewed in the direction of the longitudinal axis, always assume the same position, which benefits the precision of the tool length adjustment.

Naturally, the flute 44 and the elastomer ring 45 can be analogously mounted at the end of the clamping nut 8.

Miscellaneous

Finally, it should also be noted that the features or all of the features of this invention can be used in analogous fashion on existing systems, as was the case according to WO 2008049621 A2 and DE 102015002943.

The invention can also be used in a chuck in which an outer sleeve with a conical inner surface is pulled over a chuck body with a complementary outer cone and cylindrical internal bore. In this case, the chuck body is compressed by means of elastic deformation, thus reducing the size of the internal bore. The internal bore accommodates the shaft of the tool that is to be clamped, the shaft being either clamped directly or clamped by means of a cylindrical intermediate sleeve. The outer sleeve can be connected in a rotatable, but tension-proof fashion to a roller bearing-supported nut according to the invention so that the clamping procedure can be carried out with a relatively low torque on the nut.

Because of this, separate protection, which is independent of the claims that have been formulated up to this point, is also claimed for a chuck that has a chuck body, a coupling section for coupling the collet chuck to the working spindle of a machine tool, and at least one thread groove for the screwing-on of a clamping nut, and a sleeve part that produces a cylindrical tool shaft socket, with an outer cone and a clamping sleeve that has a preferably complementary inner cone and a clamping nut, which is coupled to the clamping sleeve in a rotatable, but tension-proof fashion and can pull the clamping sleeve in a position in which it compresses the sleeve part so that the tool shaft is fixed in position in the sleeve part in a frictional, nonpositive fashion, where the clamping nut also supports at least one thread groove, characterized in that rolling elements are inserted between the thread grooves of the chuck body and the clamping nut so that the clamping nut and the chuck body constitute a rolling element screw drive by means of which the clamping sleeve is driven into its open or closed position.

This variant of the invention is not shown independently in the drawings, but the person skilled in the art understands that the things shown in the given drawings advantageously also apply to this embodiment. This is because for the specific embodiment of the rolling element screw drive, it does not in the end matter whether it drives a collet with an outer cone into a sleeve part with an inner cone embodied in the chuck body and thus fixes the tool shaft in position by means of frictional, nonpositive engagement or whether (in the kinematic reverse, so to speak) it drives a clamping sleeve with an inner cone via a sleeve part embodied on the chuck body with an outer cone and thus fixes the tool shaft in position by means of frictional, nonpositive engagement.

1. A collet chuck, comprising:
a chuck body;
a collet; and
a clamping nut having at least one thread groove,
wherein the chuck body has a coupling section for coupling the collet chuck to a working spindle of a machine tool and has a collet holder embodied in the form of an inner cone and at least one thread groove for screwing on the clamping nut,
the collet has an outer cone, which is complementary to the inner cone, and a cylindrical tool holder,
the collet chuck is embodied so that by tightening the clamping nut, the collet can be driven far enough into the collet holder that the tool shaft is held in a rotationally secured fashion, and
rolling elements are inserted between the thread grooves of the chuck body and the clamping nut so that the clamping nut and the chuck body constitute a rolling element screw drive.

2. The collet chuck according to claim 1, wherein successive rolling elements touch one another.

3. The collet chuck according to claim 1, further comprising at least one deflecting system for the return transport of the rolling elements, wherein the deflecting system transports a rolling element, which has reached an end of the thread grooves of the chuck body or the clamping nut during actuation of the clamping nut (13), back to a beginning of the thread grooves.

4. The collet chuck according to claim 3, wherein the deflecting system is a tubular deflecting system comprising a tube, which at the end of the thread grooves of the chuck body or clamping nut, discharges a rolling element from the thread grooves, transports the rolling element outside the thread grooves to the beginning of the same thread grooves, and feeds the rolling element back in between the thread grooves.

5. The collet chuck according to claim 4, wherein the tubular deflecting system comprises a deflecting element that is embodied separately from the chuck body and clamping nut and is inserted into a first corresponding recess in the chuck body or clamping nut and is fixed in position therein.

6. The collet chuck according to claim 5, wherein the deflecting element participates in a formation of the thread groove of the chuck body or the clamping nut.

7. The collet chuck according to claim 5, further comprising:
a second recess in the chuck body or clamping nut on a side of the chuck body or clamping nut diametrically opposite from a location in which the deflecting element is installed; and
a balancing element is inserted into the second recess and fastened therein, whose mass and mass distribution are selected so that the balancing element compensate for an imbalance initially caused by the deflecting element and the rolling elements contained in the deflecting element.

8. The collet chuck according to claim 7, wherein the balancing element participates in the formation of the thread groove of the chuck body or the clamping nut.

9. The collet chuck according to claim 1, wherein either the clamping nut or the chuck body contains the rolling elements in captive fashion.

10. The collet chuck according to claim 1, wherein the rolling elements are balls and the respective thread groove of the clamping nut or of the chuck body encompasses the balls that the thread groove contains by more than 50%.

11. The collet chuck according to claim 1, wherein at least one thread groove has a continuous flute, which extends along the thread groove and lies outside of a flow of force flowing via the rolling elements.

12. The collet chuck according to claim 1, wherein:
the collet has a collar that protrudes from the collet holder and its outer circumference has a continuous, intrinsically closed rolling element-containing channel;
in a place where an inner circumference of the clamping nut faces the outer circumference of the collar, the clamping nut likewise has a rolling element-containing channel; and
the collet and the clamping nut are connected to each other in a direction along a rotation axis of the collet chuck by the rolling elements being inserted into their rolling element-containing channels.

13. The collet chuck according to claim 12, wherein either the clamping nut is composed of two parts and is composed of a first part, which supports the thread groove for receiving the rolling elements, and a second part, which has the rolling element-containing channel for connecting to the collet, and a dividing line between the two parts is embodied so that after the connection between these two parts is detached, the second part together with the collet can be removed from the chuck body, while the first part remains on the chuck body or the collet is composed of two parts in such a way that the collar of the collet can be detached from a sleeve-shaped part of the collet.

14. The collet chuck according to claim 13, wherein the first part of the clamping nut or collet and the second part of the clamping nut or collet are detachably connected to each other by a bayonet connector or a thread.

15. The collet chuck according to claim 12, wherein the clamping nut and the chuck body are embodied so that an end of the clamping nut oriented away from the collar of the collet strikes against the chuck body when the maximum tightening of the clamping nut has been reached and the end of the clamping nut oriented away from the collar of the collet does not strike directly against the chuck body, but rather with an interposition of an elastically flexible element in the form of a plastic- or elastomer ring.

16. The collet chuck according to claim 15, wherein the clamping nut also strikes against an end of the chuck body oriented toward the collar of the collet when the maximum tightening of the clamping nut has been reached.

17. The collet chuck according to claim 1, a further comprising a seal mounted adjacent to two ends of the thread groove of the chuck body.

18. The collet chuck according to claim 1, wherein a play or prestressing of the rolling elements, which is present between the chuck body and the clamping nut when the collet is released, is dimensioned so that even when the collet is driven all the way into the chuck body and the resulting elastic expansion of the chuck body occurs in a region of the collet holder, no impermissible distortion of the rolling elements occurs.

19. The collet chuck according to claim 1, wherein the rolling elements are each embodied in the form of a rhombus, with a cone angle (α) between two opposing surface lines of a rolling cone of the rhomboid rolling element of less than 45°.

20. The collet chuck according to claim 1, wherein the rolling elements are each embodied as barrel-shaped or as cylindrical rollers.

21. The collet chuck according to claim 5, wherein the deflecting element has a rolling element catching device that is an integral component thereof and exerts a force on a rolling element, which reaches the deflecting element at the end of the thread groove, in a radially inward or radially outward direction depending on whether the deflecting element is built into the chuck body or into the clamping nut, which force pushes the rolling element into a tunnel of the deflecting element.

22. The collet chuck according to claim 1, wherein an outer circumference of the clamping nut has at least one flute or a plurality of flutes that weakens the clamping nut and that is embodied as endless in a circumference direction, i.e. as an intrinsically closed flute, and is embodied as an annular groove or as a meandering or wave-shaped meandering flute.

23. The collet chuck according to claim 1, wherein an inner circumference of the clamping nut has at least one internal groove, which weakens the clamping nut and which is embodied as endless in a circumference direction, i.e. an intrinsically closed flute, and is embodied as an annular groove, where the internal groove, viewed in a direction of a longitudinal axis L lies between two flutes that are provided in its outer circumference.

24. A chuck body for a collet chuck having the features relating to the chuck body according to claim 1, wherein the chuck body has at least one thread groove for accommodating rolling elements of a rolling element screw drive.

25. A clamping nut for a collet chuck having the features relating to the chuck body according to claim 1, wherein the clamping nut has at least one thread groove for accommodating rolling elements of a rolling element screw drive.

26. A collet for a collet chuck according to claim 1.

27. A method for producing a collet according to claim 1, comprising using a generative layer producing method to produce the collet chuck and/or a deflecting element and/or the chuck body and/or at least a sleeve part.
